(19) United States
(12) Patent Application Publication
(10) Pub. No.: US 2008/0035731 A1
(43) Pub. Date: Feb. 14, 2008

(54) Image capture device with adjustable range and related methods

(76) Inventor: Chris Brock, Manorville, NY (US)

Correspondence Address: FAY KAPLUN & MARCIN, LLP, 15O BROADWAY, SUITE 702, NEW YORK, NY, 10038, US

(21) Appl. No.: 11/501,534

(22) Filed: Aug. 9, 2006

(51) Int. Cl. G06K 7/10

(52) U.S. Cl. 235/462.24; 235/462.23

(57) ABSTRACT

Described is an image capture device with an adjustable range and related methods. The device comprises an illumination element, an array imager and a microcontroller. The illumination element is initialized to a first illumination intensity and a first illumination pulse duration. The array imager utilizes a first exposure time. The array imager achieves a first imaging range based on the first illumination intensity, the first illumination pulse duration and the first exposure time. The microcontroller changes at least one of (i) the first illumination intensity to a second illumination intensity (ii) the first illumination pulse duration to a second illumination pulse duration and (iii) the first exposure time to a second exposure time. The array imager achieves a second imaging range as a function of at least one of the second illumination intensity, the second illumination pulse duration and the second exposure time.

### FIELD OF INVENTION

The present invention generally relates to an image capture device having an adjustable range and related methods.

### BACKGROUND

A conventional bar code presentation scanner may be mounted on, for example, a checkout counter and allow a user to scan bar codes by presenting items in an imaging field thereof. A conventional bar code swipe scanner allows a user to scan bar codes by “swiping” items through an imaging field thereof. Swiping refers to an act of dynamically moving the items through the imaging field of the swipe scanner, whereas the items are simply held stationary in front of the presentation scanner.

Both presentation and swipe scanners may be continuously powered and constantly attempting to decode bar codes which are detected in their respective scanning ranges. However, to ensure that all bar codes are scanned, the scanners are typically configured for a maximum scanning range. Thus, because the scanners are constantly attempting to decode the bar codes detected within their maximum scanning ranges, the scanners may detect and attempt to decode bar codes which were previously scanned (duplicate scans) and/or bar codes which are not intended to be scanned (inadvertent scans). The duplicate and inadvertent scans can frustrate the user and lead the user to believe that the scanners are malfunctioning.

### SUMMARY OF THE INVENTION

The present invention relates to an image capture device with an adjustable range and related methods. The device comprises an illumination element, an array imager and a microcontroller. The illumination element is initialized to a first illumination intensity and a first illumination pulse duration. The array imager utilizes a first exposure time. The array imager achieves a first imaging range based on the first illumination intensity, the first illumination pulse duration and the first exposure time. The microcontroller changes at least one of (i) the first illumination intensity to a second illumination intensity (ii) the first illumination pulse duration to a second illumination pulse duration and (iii) the first exposure time to a second exposure time. The array imager achieves a second imaging range as a function of at least one of the second illumination intensity, the second illumination pulse duration and the second exposure time.

### BRIEF DESCRIPTION OF THE DRAWINGS

FIG. 1 shows an exemplary embodiment of an image capture device having an adjustable range according to the present invention.

FIG. 2 shows an exemplary embodiment of a method for adjusting a range of an image capture device according to the present invention.

FIG. 3 shows an exemplary embodiment of an architecture of an image capture device having an adjustable range according to the present invention.

### DETAILED DESCRIPTION

The present invention may be further understood with reference to the following description and the attached drawings, wherein like elements are referred to with the same reference numerals. The present invention describes an image capture device with an adjustable range and related methods. While the exemplary embodiments of the present invention will be described with reference to an imager-based scanner using an array imager, those of skill in the art will understand that the present invention may be utilized by any image capture device, e.g., an imager-based scanner, a digital camera, a camera phone, a camera PDA, a web cam, a video camera, etc.

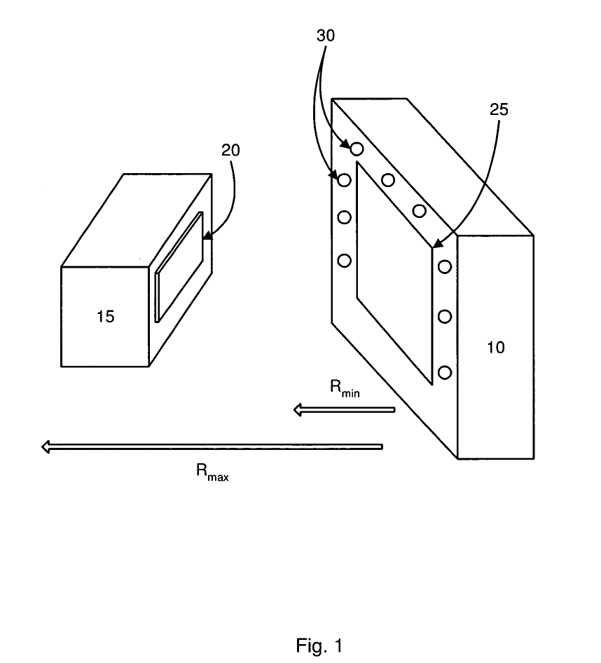

FIG. 1 shows an exemplary embodiment of a scanner 10 having an adjustable scanning range according to the present invention. As is known by those of skill in the art, the scanner 10 may be immovably mounted on a checkout counter, a stanchion/wall in a retail store or a warehouse, etc. and be used for presentation and/or swipe scanning. That is, the scanner 10 may be configured to constantly attempt to decode bar codes within its scanning range. Thus, a user may simply swipe an item 15 past the scanner 10 or present the item 15 to the scanner 10 to decode a bar code 20 on the item 15.

In the exemplary embodiment, the scanner 10 may comprise an array imager 25 and an illumination element (e.g., one or more LEDs 30). The array imager 25 may be formed from an array or matrix of pixels and be used to decode both one- and two-dimensional bar codes, as well as generate images of other indicia (e.g., text, graphics, etc.). The LEDs 30 provide illumination (e.g., visible light, infrared light, etc.) to illuminate items, e.g., the item 15, in the scanning range of the scanner 10. The array imager 25 collects illumination reflected from the item 15, and converts the reflected illumination into an analog signal. The analog signal is then converted into a digital image which the scanner 10 attempts to decode. For example, the image may include an image of the bar code 20, which is decoded by the scanner 10 (or a remote processing device coupled thereto).

The scanning range of the scanner 10 may extend from a minimum range Rₘᵢₙ (e.g., ˜6 inches) to a maximum range Rₘₐₓ (e.g., ˜18 inches). Preferably, the scanning range extends from approximately twelve to fifteen inches. When the bar code 20 is within the scanning range, the scanner 10 may generate a decodable image thereof. However, when the bar code 20 is beyond the Rₘₐₓ, the bar code 20 may not be sufficiently illuminated by the illumination from the LEDs 30 to generate the decodable image. When the bar code 20 is closer than the Rₘᵢₙ, the image of the bar code 20 may be too large to be decoded. Thus, the scanning range is conventionally initialized to the Rₘₐₓ (e.g., maximum intensity for LEDs 30) to ensure that all bar codes which are swiped-past/presented-to the array imager 25 receive sufficient illumination to generate decodable images.

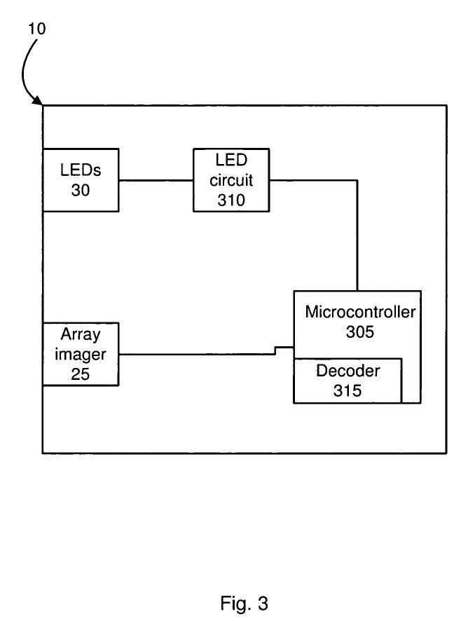

According to the exemplary embodiments of the present invention, the scanning range may be adjusted by varying one or more settings of the scanner 10. The settings may include, for example, a raw intensity of the illumination emitted by the LEDs 30, an illumination pulse duration of the LEDs 30, an exposure time of the array imager 25, etc. The settings may be varied singularly or in combination to adjust the scanning range of the scanner 10. FIG. 3 shows an exemplary embodiment of an architecture of the scanner 10 which includes a microcontroller 305, an LED circuit 310 and a decoder 315. The microcontroller 305 may vary the settings of the scanner 10 to achieve a desired scanning range, as will be described further below.

The raw intensity of the LEDs 30 may correspond to a brightness of the illumination emitted by the LEDs 30. In one exemplary embodiment, the LEDs 30 may be continually powered, while in other exemplary embodiments, the LEDs 30 may be pulsed substantially in synchronization with the decoder 315, as described below. A decrease in the raw intensity may cause a corresponding decrease in the scanning range, because, when the item 15 is beyond the scanning range, the bar code 20 will not reflect a sufficient amount of illumination to the array imager 25 to generate a decodable image. Similarly, an increase in the raw intensity may cause a corresponding increase in the scanning range. The raw intensity may be configured during set-up of the scanner 10, automatically by the scanner 10 or manually by a user, as will be explained further below.

The illumination pulse duration of the LEDs 30 may be predefined time intervals for which the LEDs 30 (or selected ones thereof) are alternately powered up and powered down. By exposing the item 15 to the illumination only for the predefined time intervals (“flashing” the LEDs 30), the illumination available to be reflected by the item 15 may be reduced, limiting the scanning range. Additionally, limiting the time that the item 15 is exposed to the illumination may reduce and/or eliminate an effect of ambient light in the decoding process. That is, the ambient light (e.g., natural light, fluorescent light, etc.) may be reflected, along with the illumination from the LEDs 30, onto the array imager 25 and included in the digital image. In the exemplary embodiment, the microcontroller 305 may control the LED circuit 310 (e.g., a current limiter) to vary current going through the LEDs 30 in accordance with the predefined time intervals. The LED circuit 310 may also vary the current to control the raw illumination intensity of the LEDs 30.

The exposure time is a predetermined time period for which the array imager 25 receives light (e.g., the reflected illumination and ambient light) and generates the digital image for the decoder 315 to decode. Those of skill in the art will understand that the exposure time may vary depending on a scanning mode utilized by the scanner 10. For example, in a presentation scanning mode where the bar code 20 is substantially stationary relative to the scanner 10, the exposure time may be on the order of approximately tens of milliseconds. However, in a swipe scanning mode where the bar code 20 is in motion relative to the scanner 10, the exposure time may be on the order of hundreds of microseconds. Preferably, the exposure time is short enough to limit or eliminate an effect of ambient light in the decoding process. By using a short exposure time, the scanner 10 may limit the effect of the ambient light such that the illumination available for reflectance by the item 15 is essentially limited to the illumination provided by the LEDs 30.

Those of skill in the art will understand that the microcontroller 305 typically synchronizes the illumination pulse duration with the exposure time. Activation of the array imager 25 to receive light may immediately follows or be substantially simultaneous with the flash of the LEDs 30 (i.e., the illumination pulse duration time interval). Synchronization of the exposure time to the illumination pulse duration may virtually eliminate any ambient light in the image generated by the array imager 25.

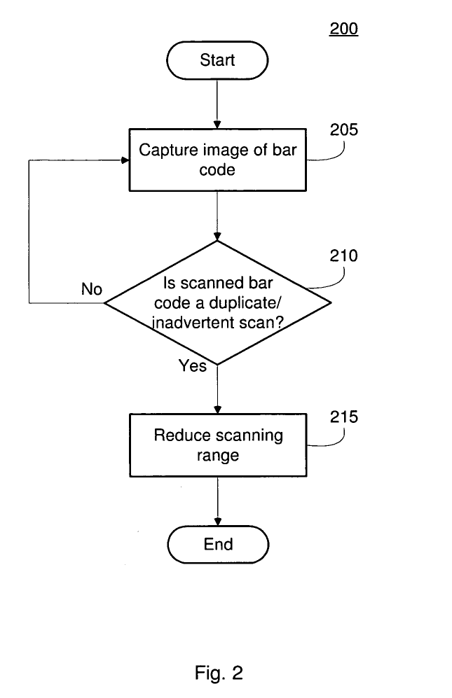

FIG. 2 shows an exemplary embodiment of a method 200 for adjusting the scanning range of the scanner 10. As noted above, the scanning range is conventionally configured to the Rₘₐₓ of the scanner 10 regardless of the use and/or location of the scanner 10. For example, even when the scanner 10 is used on a checkout counter, the scanning range may be set to Rₘₐₓ even though items may not be swiped/presented any farther than eight inches from the scanner 10. According to the exemplary embodiments of the present invention, the scanning range may be adjusted automatically by the scanner 10 or manually by the user. Automatic adjustment of the scanning range by the scanner 10 may be effected as described in U.S. patent application Ser. No. 11/007,403, entitled “Pulsed Illumination in Imaging Reading”, the entire disclosure of which is expressly incorporation herein by reference. As understood by those of skill in the art, the initial setting of the scanning range may be any setting and need not be the Rₘₐₓ. For example, the scanning range may be the Rₘᵢₙ and not register scans of items swiped beyond the Rₘᵢₙ. However, the exemplary embodiment of the method 200 will be described as though the scanning range is initially set to the Rₘₐₓ.

In step 205, the scanner 10 captures an image of the bar code 20. If the decoding is unsuccessful, the scanner 10 may capture and attempt to decode a further image, described above as the process of swipe scanning. When the image is decodable and the bar code 20 on the item 15 is decoded, it is determined whether the scanning range should be adjusted.

In step 210, it is determined whether the scanned bar code is the result of a duplicate scan or an inadvertent scan. Alternatively, it may be determined whether the scanner 10 is registering scans of the item 15 (e.g., when the scanning range is initially set to a range less than the Rₘₐₓ). As described above, the scanner 10 may be continuously powered and constantly attempting to decode. Thus, the scanner 10 may detect and attempt to decode bar codes in its scanning range which were previously scanned (duplicate scans) and/or bar codes which are not intended to be scanned (inadvertent scans). For example, the scanner 10 may be implemented as a kiosk in a retail store. A customer may scan the bar code 20 on the item 15 to obtain information about the item 15. However, because the scanner 10 is constantly attempting to decode, it may detect other bar codes within its scanning range (e.g., another customer walking by the scanner 10 holding a further item with a further bar code). As such, other information corresponding to the further item may appear which is not desired by the customer.

Whether the bar code scanned is the result of the duplicate or inadvertent scan may be determined by the user and/or by the scanner 10. In the former case, the user may provide an indication to the scanner 10 that the bar code should not have been scanned. For example, the scanner 10 and/or a processing device coupled to the scanner 10 may include a data input device (e.g., a touch panel, a keypad, etc.) on which the user may provide feedback to the scanner 10. The scanner 10 may utilize the feedback from the user to determine that the bar code is the result of a duplicate or inadvertent scan and adjust the scanning range accordingly.

In step 215, the scanning range of the scanner 10 is reduced (or otherwise adjusted). The reduction of the scanning range may be effected as described above. For example, the raw intensity of the illumination emitted by the LEDs 30, the illumination pulse duration of the LEDs 30 and/or the exposure time may be adjusted. The adjustments may be accomplished via a software interface with the scanner 10. For example, a processing device coupled to the scanner 10 may provide an application for configuring the settings of the scanner 10. The user may enter changes to the settings of the scanner 10 on the application.

Alternatively, the scanning range may be adjusted using one or more hardware components on the scanner 10. For example, a knob, dial, switch, etc. may be disposed on the scanner 10 which is used to adjust the scanning range. Turning the knob/dial or repositioning the switch may increase/decrease the scanning range. That is, the microcontroller 305 may respond to changes in the knob/dial/switch by making corresponding changes to the raw intensity of the illumination from the LEDs 30, the illumination pulse duration and/or the exposure time. For example, if the user tunes the knob to a scanning range of five inches, a corresponding reduction of the raw intensity, illumination pulse duration and/or exposure time may be affected to decrease the scanning range from, in the exemplary embodiment, the Rₘₐₓ to five inches.

Those of skill in the art will understand that the present invention may provide several advantages. For example, as described above, the present invention reduces and/or eliminates duplicate and/or inadvertent scans. Thus, the user may not think that the scanner 10 is malfunctioning. False indications of malfunction may be problematic in that the scanner 10 is typically taken offline for diagnostic exams and may be returned to the manufacturer or a third-party for repair. However, the scanning range may simply have been too great. Therefore, by implementing the exemplary embodiments of the present invention, the user can adjust the scanning range during set-up or on-the-fly.

The present invention has been described with the reference to the above exemplary embodiments. However, those of skill in the art will understand that various modifications and changes may be made to the embodiments without departing from the broadest spirit and scope of the present invention as set forth in the claims that follow. The specification and drawings, accordingly, should be regarded in an illustrative rather than restrictive sense.

1. A device, comprising:
an illumination element initialized to a first illumination intensity and a first illumination pulse duration;
an array imager utilizing a first exposure time, the array imager achieving a first imaging range based on at least one of the first illumination intensity, the first pulse illumination duration and the first exposure time; and
a microcontroller changing at least one of (i) the first illumination intensity to a second illumination intensity (ii) the first illumination pulse duration to a second illumination pulse duration and (iii) the first exposure time to a second exposure time,
wherein the array imager achieves a second imaging range as a function of at least one of the second illumination intensity, the second illumination pulse duration and the second exposure time.

2. The device according to claim 1, wherein the first illumination intensity is a maximum illumination intensity achievable by the illumination element.

3. The device according to claim 1, wherein the first illumination pulse duration is zero.

4. The device according to claim 1, wherein the first imaging range is about fifteen inches.

5. The device according to claim 1, wherein a pulse of the illumination element occurs substantially simultaneously with an exposure of the array imager.

6. The device according to claim 1, wherein the illumination element is at least one light emitting diode.

7. The device according to claim 6, wherein the at least one light emitting diode emits one of visible and infrared light.

8. The device according to claim 1, wherein the second imaging range is about twelve inches.

9. The device according to claim 1, further comprising:
an illumination circuit coupled to the illumination element and the microcontroller, the illumination circuit varying a current provided to the illumination element as a function of the change to at least one of the second illumination intensity and the second illumination pulse duration.

10. A device, comprising:
an illumination element initialized to a first illumination intensity and a first illumination pulse duration;
an array imager utilizing a first exposure time, the array imager achieving a first imaging range based on at least one of the first illumination intensity, the first illumination pulse duration and the first exposure time;
a control device changing at least one of (i) the first illumination intensity to a second illumination intensity (ii) the first illumination pulse duration to a second illumination pulse duration and (iii) the first exposure time to a second exposure time,
wherein the array imager achieves a second imaging range as a function of at least one of the second illumination intensity, the second illumination pulse duration and the second exposure time.

11. The device according to claim 10, wherein the control device is at least one of a knob, a dial and a switch.

12. The device according to claim 10, further comprising:
a microcontroller sensing movement of the control device, the microcontroller changing the at least one of (i) the first illumination intensity to the second illumination intensity (ii) the first illumination pulse duration to the second illumination pulse duration and (iii) the first exposure time to the second exposure time as a function of the sensed movement.

13. The device according to claim 10, wherein the first illumination intensity is a maximum illumination intensity achievable by the illumination element.

14. The device according to claim 10, wherein a pulse of the illumination element occurs substantially simultaneously with an exposure by the array imager.

15. The device according to claim 10, wherein the illumination element is at least one light emitting diode.

16. A device, comprising:
an illumination means initialized to a first illumination intensity and a first illumination pulse duration;
an imager means utilizing a first exposure time, the imager means achieving a first imaging range based on at least one of the first illumination intensity, the first illumination pulse duration and the first exposure time; and
a controller means for changing at least one of (i) the first illumination intensity to a second illumination intensity (ii) the first illumination pulse duration to a second illumination pulse duration and (iii) the first exposure time to a second exposure time,
wherein the imager means achieves a second imaging range as a function of at least one of the second illumination intensity, the second illumination pulse duration and the second exposure time.

17. A method, comprising:
capturing an image using an array imager, the image including a decodable element;
decoding the decodable element;
determining whether the image of the decodable element was inadvertently captured; and
adjusting an imaging range of the array imager when it is determined that the image of the decodable element was inadvertently captured.

18. The method according to claim 17, wherein the adjusting includes changing at least one of (i) a first illumination intensity of an illumination element of the array imager to a second illumination intensity, (ii) a first illumination pulse duration of the illumination element to a second illumination pulse duration and (iii) a first exposure time of the array imager to a second exposure time.

19. The method according to claim 17 wherein the decodable element is a bar code.

20. The method according to claim 17, wherein the determining includes receiving input from a user.
